(19) United States
(12) Patent Application Publication
(10) Pub. No.: US 2026/0323005 A1
(43) Pub. Date: Oct. 15, 2026

(54) CROSS-COMPONENT PREDICTION

(71) Applicant: TENCENT TECHNOLOGY (SHENZHEN) COMPANY LIMITED, Shenzhen (CN)

(72) Inventors: Renjie CHANG, Shenzhen (CN); Liqiang WANG, Shenzhen (CN); Xiaozhong XU, Shenzhen (CN)

(73) Assignee: TENCENT TECHNOLOGY (SHENZHEN) COMPANY LIMITED, Shenzhen (CN)

(21) Appl. No.: 19/670,897

(22) Filed: May 7, 2026

Related U.S. Application Data
(63) Continuation of application No. PCT/CN2025/090923, filed on Apr. 24, 2025.

(30) Foreign Application Priority Data
Jun. 7, 2024 (CN) 202410745178.2

(51) Int. Cl. H04N 19/105; H04N 19/176; H04N 19/182; H04N 19/186

(52) U.S. Cl. CPC H04N 19/105; H04N 19/176; H04N 19/182; H04N 19/186

(57) ABSTRACT

Based on a template area adjacent to a current block, a cross-component prediction model is constructed. A size of the template area is determined based on one or more attributes of the current block, the template area includes at least one of a first area on a left side of the current block and a second area above the current block. The size of the template area includes at least one of a width of the first area and a height of the second area, and the one or more attributes include at least one of a position of the current block, a correlation between the current block and an adjacent area, a size of the current block, and a resolution of the current frame. A predicted chrominance component value of a pixel is generated based on the cross-component prediction model and a reconstructed luminance component value of the pixel.

### RELATED APPLICATIONS

The present application is a continuation of International Application No. PCT/CN2025/090923, filed on Apr. 24, 2025, which claims priority to Chinese Patent Application No. 202410745178.2, filed on Jun. 7, 2024. The entire disclosures of the prior applications are hereby incorporated by reference.

### FIELD OF THE TECHNOLOGY

This application relates to the field of computer and communication technologies, including a cross-component prediction method, a video encoding/decoding method and apparatus, a medium, and a device.

### BACKGROUND

As video technologies are widely applied to fields such as digital media, real-time communication, education and entertainment, higher requirements are imposed on high efficiency and real-time performance of video encoding/decoding. In the field of video encoding/decoding, predictive coding may be performed by using a prediction model (for example, a nonlinear prediction model or a linear prediction model), and the prediction model usually needs to determine a template parameter by using data in a template area.

### SUMMARY

Embodiments of this disclosure include a cross-component prediction method, a video encoding/decoding method and apparatus, a medium, and a device, to achieve adaptive size adjustment of a template area, thereby facilitating improving video encoding performance and reducing hardware costs.

Some aspects of the disclosure provide a method of cross-component prediction. In some examples, based on one or more pixels in a template area adjacent to a current block in a current frame, a cross-component prediction model for the current block is constructed. A size of the template area for constructing the cross-component prediction model for the current block is determined based on one or more attributes of the current block, the template area includes at least one of a first area on a left side of the current block and a second area above the current block. The size of the template area includes at least one of a width of the first area and a height of the second area, and the one or more attributes of the current block include at least one of a position of the current block in the current frame, a correlation between the current block and an adjacent area of the current block, a size of the current block, and a resolution of the current frame. At least a predicted chrominance component value of a pixel in the current block is generated based on the cross-component prediction model and a reconstructed luminance component value of the pixel.

Some aspects of the disclosure provide a method of video decoding. In some examples, a video bitstream is received, the video bitstream includes coded information of a current frame including a current block. A size of a template area of the current block is determined based on one or more attributes of the current block, the template area includes at least one of a first area on a left side of the current block and a second area above the current block, the size of the template area includes at least one of a width of the first area and a height of the second area, and the one or more attributes of the current block include at least one of a position of the current block in the current frame, a correlation between the current block and an adjacent area of the current block, a size of the current block, and a resolution of the current frame. Based on one or more pixels in the template area, a cross-component prediction model for the current block is constructed. At least a predicted chrominance component value of a pixel in the current block is generated based on the cross-component prediction model and a reconstructed luminance component value of the pixel. The current block is reconstructed based on the predicted chrominance component value of the pixel.

Some aspects of the disclosure provide a method of video encoding. In some examples, a size of a template area of a current block in a current frame is determined based on one or more attributes of the current block. The template area includes at least one of a first area on a left side of the current block and a second area above the current block, the size of the template area includes at least one of a width of the first area and a height of the second area, and the one or more attributes of the current block include at least one of a position of the current block in the current frame, a correlation between the current block and an adjacent area of the current block, a size of the current block, and a resolution of the current frame. Based on one or more pixels in the template area, a cross-component prediction model for the current block is constructed. At least a predicted chrominance component value of a pixel in the current block is generated based on the cross-component prediction model and a reconstructed luminance component value of the pixel. The current block is encoded into coded information in a video bitstream based on the predicted chrominance component value of the pixel.

Some aspects of the disclosure provide an apparatus that includes processing circuitry configured to perform any of the methods described herein.

Some aspects of the disclosure provide a non-transitory computer-readable storage medium storing instructions which when executed by at least one processor cause the at least one processor to perform any of the methods described herein.

An embodiment of this disclosure includes a cross-component prediction method, including: constructing, based on a pixel value included in a template area adjacent to a current block, a cross-component prediction model corresponding to the current block, a size of the template area being determined based on video frame information corresponding to the current block, the template area including a first area located on a left side of the current block and a second area located above the current block, the size of the template area including at least one of a width of the first area or a height of the second area, and the video frame information including at least one of a position of the current block in a video frame, a correlation between the current block and an adjacent area of the current block, a size of the current block, or a resolution of the video frame; and generating a chrominance component prediction value of the current block based on the cross-component prediction model and a reconstructed luminance component pixel of the current block.

An embodiment of this disclosure includes a video decoding method, including: performing decoding processing on a video bitstream, to obtain a pixel value included in a template area adjacent to a current block; constructing, based on the pixel value included in the template area, a cross-component prediction model corresponding to the current block, a size of the template area being determined based on video frame information corresponding to the current block, the template area including a first area located on a left side of the current block and a second area located above the current block, the size of the template area including at least one of a width of the first area or a height of the second area, and the video frame information including at least one of a position of the current block in a video frame, a correlation between the current block and an adjacent area of the current block, a size of the current block, or a resolution of the video frame; generating a chrominance component prediction value of the current block based on the cross-component prediction model and a reconstructed luminance component pixel of the current block; and performing decoding processing based on the chrominance component prediction value of the current block.

An embodiment of this disclosure includes a video encoding method, including: obtaining a pixel value included in a template area adjacent to a current block; constructing, based on the pixel value included in the template area, a cross-component prediction model corresponding to the current block, a size of the template area being determined based on video frame information corresponding to the current block, the template area including a first area located on a left side of the current block and a second area located above the current block, the size of the template area including at least one of a width of the first area or a height of the second area, and the video frame information including at least one of a position of the current block in a video frame, a correlation between the current block and an adjacent area of the current block, a size of the current block, or a resolution of the video frame; generating a chrominance component prediction value of the current block based on the cross-component prediction model and a reconstructed luminance component pixel of the current block; and performing encoding processing based on the chrominance component prediction value of the current block, to obtain an encoded video bitstream.

An embodiment of this disclosure includes a cross-component prediction apparatus, including: a processing unit, configured to construct, based on a pixel value included in a template area adjacent to a current block, a cross-component prediction model corresponding to the current block, a size of the template area being determined based on video frame information corresponding to the current block, the template area including a first area located on a left side of the current block and a second area located above the current block, the size of the template area including at least one of a width of the first area or a height of the second area, and the video frame information including at least one of a position of the current block in a video frame, a correlation between the current block and an adjacent area of the current block, a size of the current block, or a resolution of the video frame; and a generation unit, configured to generate a chrominance component prediction value of the current block based on the cross-component prediction model and a reconstructed luminance component pixel of the current block.

An embodiment of this disclosure includes a video decoding apparatus, including: a decoding unit, configured to perform decoding processing on a video bitstream, to obtain a pixel value included in a template area adjacent to a current block; a processing unit, configured to construct, based on the pixel value included in the template area, a cross-component prediction model corresponding to the current block, a size of the template area being determined based on video frame information corresponding to the current block, the template area including a first area located on a left side of the current block and a second area located above the current block, the size of the template area including at least one of a width of the first area or a height of the second area, and the video frame information including at least one of a position of the current block in a video frame, a correlation between the current block and an adjacent area of the current block, a size of the current block, or a resolution of the video frame; and a generation unit, configured to generate a chrominance component prediction value of the current block based on the cross-component prediction model and a reconstructed luminance component pixel of the current block, to perform decoding processing based on the chrominance component prediction value of the current block.

An embodiment of this disclosure includes a video encoding apparatus, including: an obtaining unit, configured to obtain a pixel value included in a template area adjacent to a current block; a processing unit, configured to construct, based on the pixel value included in the template area, a cross-component prediction model corresponding to the current block, a size of the template area being determined based on video frame information corresponding to the current block, the template area including a first area located on a left side of the current block and a second area located above the current block, the size of the template area including at least one of a width of the first area or a height of the second area, and the video frame information including at least one of a position of the current block in a video frame, a correlation between the current block and an adjacent area of the current block, a size of the current block, or a resolution of the video frame; a generation unit, configured to generate a chrominance component prediction value of the current block based on the cross-component prediction model and a reconstructed luminance component pixel of the current block; and an encoding unit, configured to perform encoding processing based on the chrominance component prediction value of the current block, to obtain an encoded video bitstream.

An embodiment of this disclosure includes a computer-readable medium, having a computer program stored therein, the computer program, when executed by a processor (an example of processing circuitry), implementing the cross-component prediction method, the video decoding method, or the video encoding method described in the foregoing embodiments.

An embodiment of this disclosure includes an electronic device, including: one or more processors; and a storage apparatus, configured to store one or more computer programs, the one or more computer programs, when executed by the one or more processors, causing the electronic device to implement the cross-component prediction method, the video decoding method, or the video encoding method described in the foregoing embodiments.

An embodiment of this disclosure includes a computer program product, including a computer program, the computer program being stored in a computer-readable storage medium (e.g., non-transitory computer-readable storage medium). A processor of an electronic device reads the computer program from the computer-readable storage medium and executes the computer program, to cause the electronic device to perform the cross-component prediction method, the video decoding method, or the video encoding method provided in the foregoing embodiments.

An embodiment of this disclosure further includes a non-volatile computer-readable storage medium, having stored therein a bitstream formed by a computer program, the non-volatile computer-readable storage medium being configured to store one or more groups of instructions configured to be executed by a computing device having a control circuit and a memory, and when the one or more groups of instructions are executed, the video decoding method provided in the embodiments of this disclosure being implemented.

An embodiment of this disclosure further includes a method for storing a video bitstream, the video bitstream being generated according to the video encoding method provided in the embodiments of this disclosure.

An embodiment of this disclosure further includes a computer storage medium, having instructions stored therein, the instructions being executable by at least one processor to perform the video encoding method provided in the embodiments of this disclosure, to generate and store a bitstream.

The foregoing general descriptions and the following detailed descriptions are explanatory and are not intended to limit this disclosure.

### BRIEF DESCRIPTION OF THE DRAWINGS

FIG. 1 is a schematic diagram of a system architecture to which a technical solution of an embodiment of this disclosure may be applied.

FIG. 2 is a schematic diagram of placement of a video encoding apparatus and a video decoding apparatus in a streaming transmission system.

FIG. 3 is a basic flowchart of a video encoder.

FIG. 4 is a flowchart of cross-component non-linear prediction.

FIG. 5 is a schematic diagram of sampling points used during cross-component non-linear prediction.

FIG. 6 is a schematic position diagram of a line buffer.

FIG. 7 is a flowchart of a cross-component prediction method according to some embodiments of this disclosure.

FIG. 8 is a schematic diagram of a template area according to some embodiments of this disclosure.

FIG. 9 is a flowchart of a video decoding method according to some embodiments of this disclosure.

FIG. 10 is a flowchart of a video encoding method according to some embodiments of this disclosure.

FIG. 11 is a block diagram of a cross-component prediction apparatus according to some embodiments of this disclosure.

FIG. 12 is a block diagram of a video decoding apparatus according to some embodiments of this disclosure.

FIG. 13 is a block diagram of a video encoding apparatus according to some embodiments of this disclosure.

FIG. 14 is a schematic structural diagram of a computer system of an electronic device configured to implement an embodiment of this disclosure.

### DETAILED DESCRIPTION

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

In addition, features, structures, or characteristics described in this disclosure may be combined in one or more embodiments in any proper manner. In the following description, many specific details are provided to fully understand the embodiments of this disclosure. However, when implementing the technical solutions of this disclosure, not all detailed features in the embodiments need to be used, one or more specific details may be omitted, or another method, element, apparatus, operation, or the like may be used.

In the embodiments of this disclosure, the term “module” or “unit” refers to a computer program having a predetermined function or a part of the computer program, and operates together with other relevant parts to achieve a predetermined objective, and may be entirely or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including the module or unit function.

The block diagrams shown in the drawings are examples of functional entities and do not necessarily correspond to physically independent entities. To be specific, the functional entities may be implemented in a software form, or in one or more hardware modules or integrated circuits, or in different networks and/or processor apparatuses and/or microcontroller apparatuses.

The flowcharts shown in the drawings are merely examples and do not necessarily include all content and operations/steps, nor do they have to be executed in the described order. For example, some operations/steps may be further divided, while some operations/steps may be merged or partially merged. Therefore, an actual execution order may change according to an actual case.

“Plurality of” mentioned herein means two or more. “And/or” describes an association relationship for describing associated objects and represents that three relationships may exist. For example, A and/or B may represent the following three cases: only A exists, both A and B exist, and only B exists. The character “/” generally indicates an “or” relationship between associated objects.

As used herein, “at least one of A, B, or C” is intended to include any one of A, B, or C, or a combination of the recited elements. Similarly, “one of A and B” includes A, B, or both.

In the field of video encoding/decoding, predictive coding may be performed by using a prediction model (for example, a nonlinear prediction model or a linear prediction model), and the prediction model usually needs to determine a template parameter by using data in a template area. If the template area is set to be excessively large, hardware costs are increased due to buffering data in the template area. If the template area is set to be excessively small, the prediction model is inaccurate, affecting a video encoding/decoding effect. Therefore, how to properly set the size of the template area is a technical problem to be resolved urgently.

In the technical solutions provided in some embodiments of this disclosure, a size of a template area of a current block is obtained through adaptive adjustment based on video frame information corresponding to the current block, to construct, based on a pixel value included in the template area adjacent to the current block, a cross-component prediction model corresponding to the current block, and generate a chrominance component prediction value of the current block based on the cross-component prediction model and a reconstructed luminance component pixel of the current block. This can avoid increasing hardware implementation costs due to an excessively large template area, and can avoid affecting a prediction result due to an excessively small template area. In this way, adaptive size adjustment of the template area is achieved, thereby facilitating improving video encoding performance and reducing hardware costs.

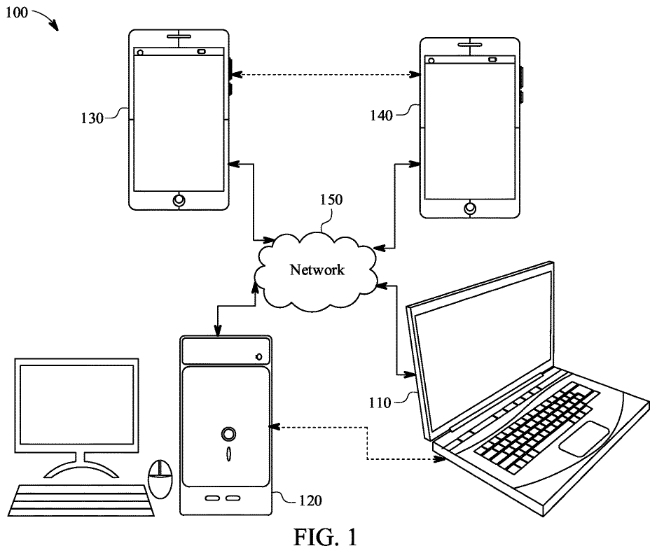

FIG. 1 is a schematic diagram of a system architecture to which a technical solution of an embodiment of this disclosure may be applied.

As shown in FIG. 1, a system architecture 100 includes a plurality of terminal apparatuses. The terminal apparatuses may communicate with each other through a network 150, for example. For example, the system architecture 100 may include a first terminal apparatus 110 and a second terminal apparatus 120 connected through the network 150. In the embodiment of FIG. 1, the first terminal apparatus 110 and the second terminal apparatus 120 perform unidirectional data transmission.

For example, the first terminal apparatus 110 may encode video data (for example, a video picture stream acquired by the terminal apparatus 110) for transmission to the second terminal apparatus 120 by using the network 150. The encoded video data is transmitted in a form of one or more encoded video bitstreams. The second terminal apparatus 120 may receive the encoded video data from the network 150, decode the encoded video data to restore the video data, and display a video picture according to the restored video data.

In some embodiments of this disclosure, the system architecture 100 may include a third terminal apparatus 130 and a fourth terminal apparatus 140 that perform bidirectional transmission of encoded video data. The bidirectional transmission may occur, for example, during a video conference. For bidirectional data transmission, each of the third terminal apparatus 130 and the fourth terminal apparatus 140 may encode video data (for example, a video picture stream acquired by the terminal apparatus) for transmission to the other of the third terminal apparatus 130 and the fourth terminal apparatus 140 by using the network 150. Each of the third terminal apparatus 130 and the fourth terminal apparatus 140 may further receive encoded video data transmitted by the other of the third terminal apparatus 130 and the fourth terminal apparatus 140, decode the encoded video data to restore video data, and display a video picture on an accessible display apparatus according to the restored video data.

In the embodiment shown in FIG. 1, the first terminal apparatus 110, the second terminal apparatus 120, the third terminal apparatus 130, and the fourth terminal apparatus 140 may be servers or terminals, but the principle disclosed in this disclosure may not be limited thereto.

The server may be an independent physical server, or may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal may be a smartphone, a tablet computer, a notebook computer, a desktop computer, a smart speaker, a smart voice interaction device, a smart watch, a smart household appliance, an on-board terminal, or an aircraft, but is not limited thereto.

The network 150 shown in FIG. 1 represents any number of networks configured to transmit encoded video data between the first terminal apparatus 110, the second terminal apparatus 120, the third terminal apparatus 130, and the fourth terminal apparatus 140, and includes, for example, a wired and/or wireless communication network. The communication network 150 may exchange data in circuit switching and/or packet switching channels. The network may include a telecommunication network, a local area network, a wide area network, and/or the Internet. For the purpose of this disclosure, unless explained below, an architecture and a topology of the network 150 may be inconsequential to operations disclosed in this disclosure.

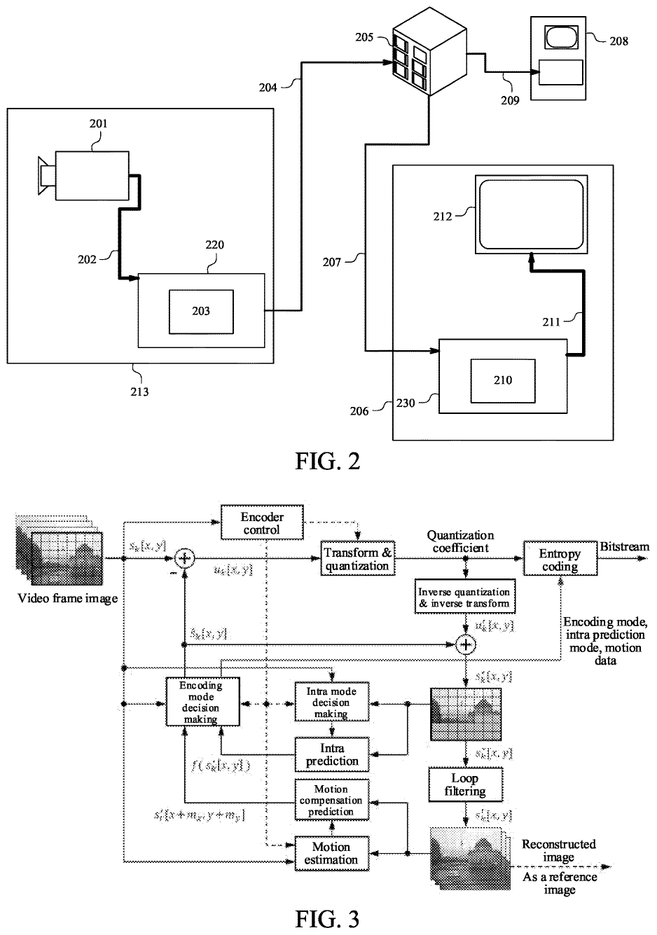

In some embodiments of this disclosure, FIG. 2 shows placement of a video encoding apparatus and a video decoding apparatus in a streaming transmission environment. The subject disclosed in this disclosure may be further applicable to other applications supporting a video, including, for example, video conferencing, a digital television (TV), and storage of a compressed video on a digital medium including a compact disc (CD), a digital video disk (DVD), a storage stick, and the like.

The streaming transmission system may include a collection subsystem 213. The collection subsystem 213 may include a video source 201 such as a digital camera. The video source creates an uncompressed video picture stream 202. In an embodiment, the video picture stream 202 includes a sample captured by a digital camera. Compared with encoded video data 204 (or an encoded video bitstream 204), the video picture stream 202 is drawn as a bold line to emphasize a video picture stream with a high data volume. The video picture stream 202 may be processed by an electronic apparatus 220. The electronic apparatus 220 includes a video encoding apparatus 203 coupled to the video source 201. The video encoding apparatus 203 may include hardware, software, or a combination of software and hardware to implement or perform aspects of the disclosed subject matter described below. Compared with the video picture stream 202, the encoded video data 204 (or the encoded video bitstream 204) is drawn as a thin line to emphasize an encoded video data 204 (or the encoded video bitstream 204) with a relatively low data volume, which may be stored on a streaming server 205 for future use. One or more streaming client subsystems, for example, the client subsystem 206 and the client subsystem 208 in FIG. 2, may access the streaming server 205 to retrieve a copy 207 and a copy 209 of the encoded video data 204. The client subsystem 206 may include, for example, a video decoding apparatus 210 in an electronic apparatus 230. The video decoding apparatus 210 decodes an incoming copy 207 of encoded video data, and generates an output video picture stream 211 that may be presented on a display 212 (such as a display screen) or another presentation apparatus. In some streaming transmission systems, the encoded video data 204, the video data 207, and the video data 209 (for example, video bitstreams) may be encoded according to some video encoding/compression standards.

The electronic apparatus 220 and the electronic apparatus 230 may include other components not shown in the figure. For example, the electronic apparatus 220 may include a video decoding apparatus, and the electronic apparatus 230 may further include a video encoding apparatus.

In some embodiments of this disclosure, by using high efficiency video coding (HEVC), multifunctional video coding (VVC), and China national video coding (such as audio video coding standard (AVS)) as an example, after a video frame image is inputted, the video frame image is partitioned into a plurality of non-overlapping processing units according to a block size, and a similar compression operation is performed on each processing unit. The processing unit is referred to as a coding tree unit (CTU) or a largest coding unit (LCU). The CTU may be further partitioned into one or more basic coding units (CU). The CU is a most basic element in an encoding process.

In some other embodiments, the processing unit may also be referred to as a code slice (that is, a tile), which is a rectangular area of a multimedia data frame that can be independently decoded and encoded. In the Alliance for Open Media Video 1 (AV1) formulated by the Alliance for Open Media, a code slice may be further partitioned into one or more superblocks (SB). An SB serves as a starting point for block division, and may be further partitioned into sub-blocks. Subsequently, the superblock may be further partitioned to obtain one or more blocks. Each block is a most basic element in an encoding process. In some embodiments, one SB may include a plurality of blocks.

The foregoing partition manner for the video frame image may be referred to as a block partition structure. The following describes some concepts in an encoding process.

Predictive coding: It includes modes such as intra prediction and inter prediction. A residual video signal is obtained after an original video signal is predicted from a selected reconstructed video signal. An encoder side needs to select a predictive coding mode for a current CU (or coding block), and notify a decoder side of the predictive coding mode. Intra prediction means that a predicted signal is from a region that is in a same picture and that has been reconstructed by encoding. Inter prediction means that a predicted signal is from another encoded picture (referred to as a reference picture) different from a current picture.

Transform and quantization: A residual video signal is transformed into a transform domain through a transform operation such as discrete Fourier transform (DFT) or discrete cosine transform (DCT), to generate a transform coefficient. The transform coefficient then undergoes lossy quantization, discarding some information so that a quantized signal becomes more conducive to compression expression. In some video coding standards, more than one transform mode is available. Therefore, the encoder side further needs to select one transform mode for the current CU (or coding block), and notify the decoder side of the transform mode. Quantization fineness usually depends on a quantization parameter (QP). A larger QP indicates that coefficients in a larger value range are to be quantized into the same output, which usually brings larger distortion and a lower bit rate. Conversely, a smaller QP indicates that coefficients in a smaller value range are to be quantized into the same output, which usually brings smaller distortion and a higher bit rate.

Entropy coding or statistical coding: Statistical compression coding is performed on a quantized transform domain signal based on a frequency of each value, ultimately outputting a binary (0 or 1) compressed bitstream. In addition, entropy coding further needs to be performed on other information generated during the encoding, such as the selected encoding mode and motion vector data, to reduce a bit rate. Statistical coding is a lossless coding mode that can effectively reduce a bit rate required for expressing a same signal. A common statistical coding mode includes variable length coding (VLC) or context adaptive binary arithmetic coding (CABAC).

A CABAC process includes three operations: binarization, context modeling, and binary arithmetic coding. After binarization processing is performed on an inputted syntactic element, binary data may be encoded by using a related encoding mode and a bypass coding mode. The bypass coding mode does not require allocating a specific probability model for each binary bit. Instead, an inputted binary bit (a bin value) is directly encoded by using a simple bypass encoder to speed up the overall encoding and decoding process. Generally, different syntactic elements are not completely independent of each other, and a same syntactic element also has some memorization. Therefore, according to the theory of conditional entropy, performing conditional coding by using other encoded syntax elements can further improve encoding performance compared to independent coding or memoryless coding. Encoded symbol information used as a condition is referred to as a context. In a related coding mode, binary bits of a syntactic element sequentially enter a context modeling device. An encoder allocates an appropriate probability model to each inputted binary bit according to a value of a syntactic element or a binary bit that has been encoded previously. This process is context modeling. A context model corresponding to a syntactic element may be positioned through context index increment (ctxIdxInc) and context index Start (ctxIdxStart). After the bin value and the allocated probability model are both fed into a binary arithmetic encoder for encoding, the context model needs to be updated according to the bin value, which is an adaptation process during encoding.

Loop filtering: Operations such as inverse quantization, inverse transform, and predictive compensation are performed on a transformed and quantized signal to obtain a reconstructed image. The reconstructed image has some information different from that in an original image as a result of quantization, that is, the reconstructed image may cause distortion. Therefore, a filtering operation may be performed on the reconstructed image, for example, by using filters such as a deblocking filter (DB), a sample adaptive offset (SAO) filter, or an adaptive loop filter (ALF), which can effectively reduce a degree of distortion caused by quantization. Because these filtered reconstructed images are used as reference for subsequent encoded images to predict a future image signal, the foregoing filtering operation is also referred to as loop filtering, that is, a filtering operation in a coding loop.

In some embodiments of this disclosure, FIG. 3 is a basic flowchart of a video encoder. In this process, intra prediction is used as an example for description. A difference between an original image signal sₖ[x, y] and a predicted image signal ŝₖ[x, y] is calculated to obtain a residual signal uₖ[x, y], and the residual signal uₖ[x, y] is transformed and quantized to obtain a quantization coefficient. The quantization coefficient is subjected to entropy coding to obtain an encoded bitstream, and is further subjected to inverse quantization and inverse transform to obtain a reconstructed residual signal u′ₖ[x, y]. The predicted image signal sₖ[x, y] is superimposed with the reconstructed residual signal u′ₖ[x, y] to generate an image signal s*ₖ[x, y]. The image signal sₖ*[x, y] is inputted to an intra mode decision module and an intra prediction module for intra prediction, and is further subjected to loop filtering to output a reconstructed image signal s′ₖ[x, y]. The reconstructed image signal s′ₖ[x, y] may be used as a reference image for a next frame for motion estimation and motion compensation prediction. Then a predicted image signal sₖ[x, y] of the next frame is obtained based on a result s′_{y}[x+mₓ, y+m_{y}] of the motion compensation prediction and a result f(sₖ*[x, y]) of the intra prediction. The foregoing process is repeated until the encoding is completed.

Based on the foregoing encoding process, on a decoder side, for each CU (or coding block), after a compressed bitstream (that is, a bitstream) is obtained, entropy decoding is performed to obtain various pattern information and quantization coefficients. Inverse quantization and inverse transform processing are then performed on the quantization coefficients to obtain a residual signal. Moreover, a predicted signal corresponding to the CU (or coding unit) may be obtained based on encoding mode information that is known. Then the residual signal and the predicted signal may be added together to obtain a reconstructed signal. The reconstructed signal is then subjected to operations such as loop filtering to generate a final output signal. In this series of encoding processes, the encoding framework primarily makes decisions based on rate-distortion optimization (RDO) to select an optimal encoding parameter.

The following introduces some prediction models for use in a prediction process during video encoding.

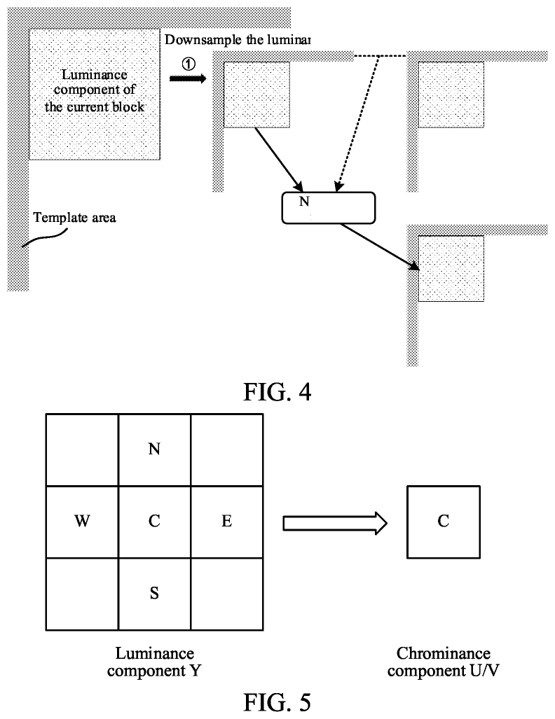

A cross-component nonlinear intra prediction model (CCNPM) constructs a cross-component prediction model for luminance and chrominance components based on adjacent pixels of a current block, and then performs intra chrominance component prediction by using reconstructed luminance component pixels of the current block. FIG. 4 shows a prediction process of the CCNPM, which includes the following three operations:

\textcircled{1}. Downsampling is performed on a luminance component of a current block and a template area (that is, a grayscale area shown in FIG. 4) adjacent to the current block, to obtain a downsampled luminance component.

\textcircled{2}. A cross-component nonlinear prediction model between a luminance component (Y) and a chrominance component (U/V) is constructed based on the adjacent template area. As shown in FIG. 5, the cross-component nonlinear prediction model uses a to-be-predicted target chrominance component sample point, a position C in a downsampled luminance component (Y) corresponding to a chrominance component sample point, and downsampled luminance component sample points (W, N, S, and E) around the position C in the downsampled luminance component (Y). Based on these sampling points obtained in the template area, the following nonlinear model structure may be constructed:

$${C}^{′} = {p}_{0} ( \frac{N + S + 4 C + W + E}{8} ) + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {{p}_{5} ( \frac{N + S + 4 C + W + E}{8} )}^{2} + {p}_{6} B .$$

C′ represents the target chrominance component sample point, pᵢ (to be specific, p₀, p₁, p₂, p₃, p₄, p₅, and p₆) represents a model parameter, and B represents a constant term. A model parameter of the CCNPM may be obtained by solving a plurality of nonlinear model equations.

\textcircled{3}. After the model parameter of the CCNPM is obtained, a downsampled luminance component sample point corresponding to the current block may be inputted to the cross-component prediction model, to obtain a chrominance component prediction value.

A size of the template area adjacent to the CCNPM is 6 lines for chrominance and 12 lines for luminance (using a YUV420 format as an example). That is, a maximum quantity of required line buffers is 12.

The CCNPM can be applied not only to intra prediction, but also to inter prediction. Therefore, the CCNPM may also be referred to as a cross-component nonlinear prediction model. Alternatively, the cross-component nonlinear prediction model applied to inter prediction may be denoted as an inter CCNPM, and a principle of the inter CCNPM is consistent with that of the CCNPM applied to intra prediction.

A cross-component linear prediction model (CCLM), another prediction model, is similar to the CCNPM, which constructs a cross-component prediction model by using luminance and chrominance component reference pixels in an adjacent template area, and then calculates a chrominance component prediction value based on a reconstructed luminance component value of the current block. The difference is that the prediction model constructed by CCLM is a linear model. The CCLM may be represented as:

$${pred}_{C} ( i , j ) = α \cdot {rec}_{L}^{′} ( i , j ) + β .$$

pred_{c}(i,j) represents a current chrominance component prediction point with coordinates of (i,j), rec_{L}′(i,j) represents a current reconstructed luminance component pixel point obtained after downsampling, and α and β are model parameters.

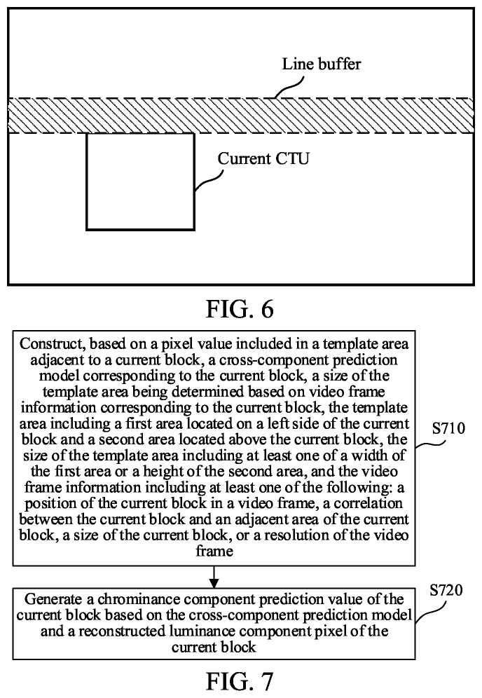

In addition, during video encoding, when prediction and filtering are performed, reconstructed pixels adjacent to the current block usually need to be used. To reserve reestablished pixels or data, video encoding employs a line buffer to cache one or more lines of pixels from an image or video frame, thereby avoiding an increase in bandwidth demands as a result of repeated reading of these data. As shown in FIG. 6, a line buffer is arranged right above each row of CTUs. A larger line buffer indicates higher costs for hardware implementation.

Therefore, although prediction technologies such as the CCNPM bring an appreciable coding gain, as data in a template area needs to be buffered, a demand for line buffers increases, resulting in an increase in costs for hardware implementation. However, if the template area is set to be excessively small, the prediction model is inaccurate, affecting a video encoding/decoding effect. To further improve encoding performance and reduce hardware costs, this embodiment of this disclosure proposes to adaptively adjust, based on video frame information, the size of the template area used by the prediction model, to further improve the encoding performance and reduce the hardware costs.

Implementation details of the technical solutions of the embodiments of this disclosure are described in further detail below.

FIG. 7 is a flowchart of a cross-component prediction method according to some embodiments of this disclosure. The cross-component prediction method may be performed by a video encoding device or a video decoding device. The video encoding device or the video decoding device may be a terminal device, a server, or the like. Referring to FIG. 7, the cross-component prediction method includes at least S710 to S720, which are described as follows:

S710: Construct, based on a pixel value included in a template area adjacent to a current block, a cross-component prediction model corresponding to the current block, a size of the template area being determined based on video frame information corresponding to the current block, the template area including a first area located on a left side of the current block and a second area located above the current block, the size of the template area including at least one of a width of the first area or a height of the second area, and the video frame information including at least one of a position of the current block in a video frame, a correlation between the current block and an adjacent area of the current block, a size of the current block, or a resolution of the video frame.

In some embodiments, a video includes a video picture frame sequence, which includes a series of pictures. Each picture may be further partitioned into slices, and each slice may be further partitioned into a series of LCUs (or CTUs). Each LCU includes a plurality of CUs. A video image frame is encoded by using a block as a unit. In some new video coding standards, for example, in the H.264 standard, a macroblock (MB) is provided. The MB may be further partitioned into a plurality of prediction blocks that may be configured for predictive coding. In the HEVC standard, basic concepts such as a CU, a prediction unit (PU), and a transform unit (TU) are utilized to define various block units in function, and a new tree-based structure is used for description. For example, a CU may be partitioned into smaller CUs according to a quadtree, and the smaller CUs may be further partitioned to form a quadtree structure. The current block in this embodiment of this disclosure may be a CU or a block smaller than the CU, for example, a smaller block obtained by partitioning the CU.

In some embodiments, the video frame information utilized for determining the size of the template area may include one or more of information such as the position of the current block in the video frame, the correlation between the current block and the adjacent area of the current block, the size of the current block, or the resolution of the video frame. Detailed descriptions are respectively provided below:

In some embodiments, the video frame information may include the position of the current block in the video frame. Therefore, during the determining of the size of the template area, if the current block is located in a first row of CTUs in the video frame, the size of the template area is determined based on a distance between a first row of pixels in the current block and an upper boundary of the video frame.

For example, when the current block is located in the first row of CTUs in the video frame, if the distance between the first row of pixels in the current block and the upper boundary of the video frame is greater than or equal to a default size (for example, a default height of the template area) of the template area, the default size is used as the size of the template area (for example, the default height is used as a height of the template area). If the distance between the first row of pixels in the current block and the upper boundary of the video frame is less than the default size, the size of the template area is determined based on the distance between the first row of pixels in the current block and the upper boundary of the video frame (for example, the distance between the first row of pixels in the current block and the upper boundary of the video frame is used as the height of the template area). The size of the template area determined in this manner may be a height of a template area located above the current block.

In some embodiments, the template area includes a first area located on a left side of the current block and a second area located above the current block, and the size of the template area includes at least one of a width of the first area or a height of the second area. For example, if the current block is located in the first row of CTUs in the video frame, the height of the second area is determined based on the distance between the first row of pixels in the current block and the upper boundary of the video frame. If the current block is not located in the first row of CTUs in the video frame, the height of the second area is determined based on a position relationship between a template area of the default size and a line buffer corresponding to a target row of CTUs, the target row of CTUs being a row of CTUs in which the current block is located.

In some embodiments, a width value of the template area (the first area) located on the left side of the current block may be set to be the same as a height value of the template area (the second area) located above the current block. Alternatively, the width of the template area (the first area) located on the left side of the current block may be determined by using a similar method.

For example, when the current block is located in a first column of CTUs in the video frame, if a distance between a first column of pixels in the current block and a left boundary of the video frame is greater than or equal to the default size of the template area (for example, a default width of the first area), the default width is used as the width of the template area (the first area) on the left side of the current block. If the distance between the first column of pixels in the current block and the left boundary of the video frame is less than the default width, the distance between the first column of pixels in the current block and the left boundary of the video frame is used as the width of the template area (the first area) on the left side of the current block.

The default size of the template area in this embodiment of this disclosure may be a specified template size, or may be a template size specified in a video encoding/decoding standard. The default template size may be configured for representing at least one of the default width of the template area (the first area) on the left side of the current block or the default height of the template area (the second area) located above the current block, and the default width of the template area (the first area) on the left side of the current block may be the same as or different from the default height of the template area (the second area) above the current block.

In some embodiments, if the current block is not located in the first row of CTUs in the video frame, the size of the template area (for example, the height of the second area) is determined based on a position relationship between a template area of the default size and a line buffer corresponding to a target row of CTUs, the target row of CTUs being a row of CTUs in which the current block is located.

For example, when the current block is not located in the first row of CTUs in the video frame, if the template area of the default size does not exceed a range of the line buffer, the default size is used as the size of the template area. If the template area of the default size exceeds the range of the line buffer, a sum of a distance between the first row of pixels in the current block and an upper boundary of the target row of CTUs and a size of the line buffer is used as the size of the template area. The size of the template area determined in this manner may be a height of the template area located above the current block. That is, if the template area of the default height does not exceed the range of the line buffer, the default height is used as the height of the template area. If the template area of the default height exceeds the range of the line buffer, the sum of the distance between the first row of pixels in the current block and the upper boundary of the target row of CTUs and the size of the line buffer is used as the height of the template area. In some embodiments, the width value of the template area located on the left side of the current block may be set to be the same as the height value of the template area located above the current block. Alternatively, the width of the template area located on the left side of the current block may be separately determined.

In some embodiments, the video frame information may include the correlation between the current block and the adjacent area of the current block. For example, the correlation may be a correlation between pixel values. In this case, during the determining of the size of the template area, the size of the template area may be determined based on a correlation between the reconstructed luminance component pixel of the current block and a luminance component pixel value in the adjacent area.

In some examples, the template area includes the first area located on the left side of the current block and the second area located above the current block, and the width of the first area and the height of the second area may be separately determined. Specific examples are as follows:

In some embodiments, a process of determining the width of the first area on the left side of the current block may include: extending the width of the first area from 1 toward a left adjacent area while remaining a right boundary of the first area fixed, and calculating an average gradient of all rows of luminance component pixels included in the first area in a horizontal direction when the width of the first area is i, to obtain an average horizontal gradient existing when the width is i; and setting the width of the first area to i-1 if an absolute difference between the average horizontal gradient existing when the width is i and an average horizontal gradient existing when the width is i-1 is greater than or equal to a set threshold; or further extending the first area leftward if the absolute difference between the average horizontal gradient existing when the width is i and the average horizontal gradient existing when the width is i-1 is less than the set threshold, until the width of the first area reaches the default width of the first area, i being a natural number greater than 1.

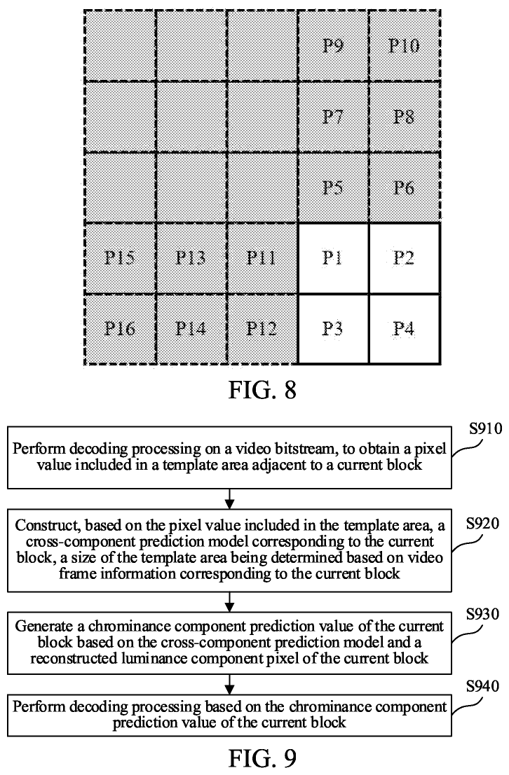

In some examples, as shown in FIG. 8, it is assumed that the current block is a block of 2×2 (a white area in FIG. 8), and includes luminance component pixels P1, P2, P3, and P4. When the width of the first area is 1, an average horizontal gradient of luminance component pixels P11 and P12 in a first area that is directly adjacent to the current block and that has the width of 1 is calculated. The average horizontal gradient is obtained by calculating pixel differences on two sides of P11 and P12, which is

$${G}_{x}^{1} = ( P 13 - P 1 ) + ( P 14 - P 3 ) .$$

If the width of the first area is extended to 2, an average horizontal gradient of luminance component pixels P11, P12, P13, and P14 in a first area that is directly adjacent to the current block and that has the width of 2 is calculated, which is

$${G}_{x}^{2} = ( ( P 13 - P 1 ) + ( P 14 - P 3 ) + ( P 15 - P 11 ) + ( P 16 - P 12 ) ) / 2.$$

### If

$$\vert {G}_{x}^{1} - {G}_{x}^{2} \vert < a$$

(a is a set threshold), which indicates that a pixel correlation between the adjacent area having the width of 2 and the adjacent area having the width of 1 in the horizontal direction is high, the first area may be further extended leftward until the width of the first area reaches the default template width. If

$$\vert {G}_{x}^{1} - {G}_{x}^{2} \vert \geq a ,$$

which indicates that the pixel correlation between the adjacent area having the width of 2 and the adjacent area having the width of 1 in the horizontal direction is low, leftward extension may be stopped, and the width of the first area is set to 1. In other words, the width of the template area located on the left side of the current block may be 1.

In some embodiments, a process of determining the height of the second area above the current block may include: extending the height of the second area from 1 toward an upper adjacent area while remaining a lower boundary of the second area fixed, and calculating an average gradient of all columns of luminance component pixels included in the second area in a vertical direction when the height of the second area is j, to obtain an average vertical gradient existing when the height is j; and setting the height of the second area to j−1 if an absolute difference between the average vertical gradient existing when the height is j and an average vertical gradient existing when the height is j−1 is greater than or equal to a set threshold; or further extending the second area upward if the absolute difference between the average vertical gradient existing when the height is j and the average vertical gradient existing when the height is j−1 is less than the set threshold, until the height of the second area reaches the default height of the second area, j being a natural number greater than 1.

In some examples, still referring to FIG. 8, it is assumed that the current block is a block of 2×2 (a white area in FIG. 8), and includes luminance component pixels P1, P2, P3, and P4. If the height of the second area is 1, an average vertical gradient is

$${G}_{y}^{1} = ( P 7 - P 1 ) + ( P 8 - P 2 ) .$$

If the height of the second area is extended to 2, an average vertical gradient is

$${G}_{y}^{2} = ( ( P 7 - P 1 ) + ( P 8 - P 2 ) + ( P 9 - P 5 ) + ( P 10 - P 6 ) ) / 2. If \vert {G}_{y}^{1} - {G}_{y}^{2} \vert < a$$

a is a set threshold), which indicates that a pixel correlation between the adjacent area having the height of 2 and the adjacent area having the height of 1 in the vertical direction is high, the second area may be further extended upward until the height of the second area reaches the default height. If

$$\vert {G}_{y}^{1} - {G}_{y}^{2} \vert \geq a ,$$

which indicates that the pixel correlation between the adjacent area having the height of 2 and the adjacent area having the height of 1 in the vertical direction is low, upward extension may be stopped, and the height of the second area is set to 1. In other words, the height of the template area located above the current block may be 1.

In some embodiments, during the determining of the size of the template area based on the correlation between the reconstructed luminance component pixel of the current block and the luminance component pixel value in the adjacent area, the template area may alternatively be extended by using the current block as a reference. In some examples, the first area is extended toward a left adjacent area; the second area is extended toward an upper adjacent area; a pixel value error between a luminance component pixel in the template area and the reconstructed luminance component pixel of the current block is calculated when the size of the template area is/(that is, the width of the first area and the height of the second area are/); and the size of the template area (that is, the width of the first area and the height of the second area) is set to 1-1 if the corresponding pixel value error existing when the size of the template area is l is greater than or equal to a set threshold; or the template area is further extended when the corresponding pixel value error existing when the size of the template area is l is less than the set threshold, until the size of the template area reaches the default size, l being a natural number greater than 1.

In some examples, still referring to FIG. 8, it is assumed that the current block is a block of 2×2 (a white area in FIG. 8), and includes luminance component pixels P1, P2, P3, and P4. If the size of the template area (that is, the height of the template area located above the current block and the width of the template area located on the left side of the current block) is extended to 2, the template area includes luminance component pixels P5, P6, P7, P8, P11, P12, P13, and P14. A pixel value error S between the luminance component pixel in the template area and the reconstructed luminance component pixel of the current block may be calculated. If S<a (ais a set threshold), which it indicates that a correlation between the template area having the size of 2 and the reconstructed luminance component pixel of the current block is high, the template area may be further extended until the size of the template area reaches the default size. If S≥a, which indicates that the correlation between the template area having the size of 2 and the reconstructed luminance component pixel of the current block is low, the template area extension may be stopped, and the size of the template area is set to 1. In other words, a size of a template area of the current block may be 1.

Because the size of the template area is different from a size and a shape of the current block, during the calculation of the pixel value error between the luminance component pixel in the template area and the reconstructed luminance component pixel of the current block, the luminance component pixel in the template area and the reconstructed luminance component pixel of the current block may be mapped to spatial areas of the same size, and a pixel value error between a mapping result of the luminance component pixel and a mapping result of the reconstructed luminance component pixel is calculated.

In some embodiments, the pixel value error may be a sum of absolute difference (SAD), a sum of squared difference (SSD), a mean squared error (MSE), or the like.

In some embodiments, the video frame information may include the size of the current block. In this case, the size of the template area may be determined based on the size of the current block. The size of the template area is positively correlated to the size of the current block, and the size of the current block may be a larger one of the width and the height of the current block. For example, if the size of the current block is less than or equal to 8, the size of the template area is 3. If the size of the current block is between 8 and 16, the size of the template area is 4 or the like.

In some embodiments, the video frame information may include the resolution of the video frame. In this case, the size of the template area may be determined based on the resolution of the video frame. The size of the template area is positively correlated to the resolution of the video frame. For example, if the resolution of the video frame is 4K, the size of the template area is 6. If the resolution of the video frame is 2K, the size of the template area is 4 or the like.

In some embodiments, for a process of constructing, based on the pixel value included in the template area adjacent to the current block, the cross-component prediction model corresponding to the current block, refer to the process shown in FIG. 4, and a similar method may be used for both the linear prediction model and the non-linear prediction model.

Referring again to FIG. 7, in S720, a chrominance component prediction value of the current block is generated based on the cross-component prediction model and a reconstructed luminance component pixel of the current block.

In some embodiments, the process of generating the chrominance component prediction value of the current block based on the cross-component prediction model and the reconstructed luminance component pixel of the current block corresponds to the process shown in FIG. 4. In some examples, the reconstructed luminance component pixel of the current block may be inputted to the cross-component prediction model, to obtain the chrominance component prediction value of the current block.

In some embodiments, the cross-component prediction model in this embodiment of this disclosure may be a cross-component nonlinear prediction model configured for intra prediction, a cross-component linear prediction model configured for intra prediction, a cross-component nonlinear prediction model configured for inter prediction, or a cross-component linear prediction model configured for inter prediction. In other words, the cross-component prediction model in this embodiment of this disclosure may be either a nonlinear prediction model or a linear prediction model, and may be applied to either intra prediction or inter prediction.

In addition, the solution for determining a template area in this embodiment of this disclosure, in addition to being applied to cross-component prediction, may be further applied to non-cross-component prediction. As long as the prediction model uses a template area, the technical solution in this embodiment of this disclosure can be utilized to determine a size of the template area, regardless of intra prediction or inter prediction, non-linear prediction or linear prediction, or cross-component prediction or non-cross-component prediction.

Based on the cross-component prediction method shown in FIG. 7, an embodiment of this disclosure further provides a video decoding method. The video decoding method may be performed by a device having a computing processing function, for example, may be performed by a terminal device or a server. A specific process is shown in FIG. 9, including S910 to S940, which are described as follows:

S910: Perform decoding processing on a video bitstream to obtain a pixel value included in a template area adjacent to a current block.

S920: Construct, based on the pixel value included in the template area, a cross-component prediction model corresponding to the current block, a size of the template area being determined based on video frame information corresponding to the current block.

S930: Generate a chrominance component prediction value of the current block based on the cross-component prediction model and a reconstructed luminance component pixel of the current block.

S940: Perform decoding processing based on the chrominance component prediction value of the current block.

For specific implementation details of S920 and S930, refer to the descriptions of S710 and S720 in the foregoing embodiment. To be specific, the video decoding device may determine the size of the template area based on the video frame information corresponding to the current block, to avoid increasing costs for hardware implementation as a result of an excessively large template area, and avoid affecting a prediction result as a result of an excessively small template area. In this way, adaptive size adjustment of the template area is achieved, thereby facilitating improving video encoding performance and reducing hardware costs.

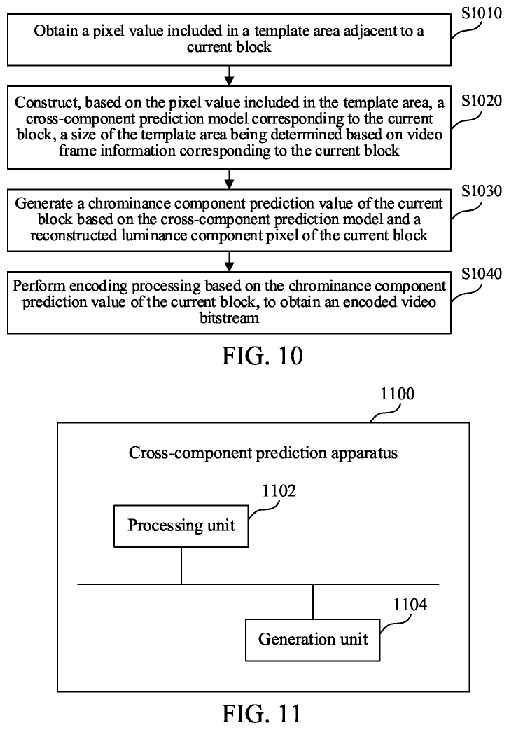

Based on the cross-component prediction method shown in FIG. 7, an embodiment of this disclosure further provides a video encoding method. The video encoding method may be performed by a device having a computing processing function, for example, may be performed by a terminal device or a server. A specific process is shown in FIG. 10, including S1010 to S1040, which are described as follows:

S1010: Obtain a pixel value included in a template area adjacent to a current block.

S1020: Construct, based on the pixel value included in the template area, a cross-component prediction model corresponding to the current block, a size of the template area being determined based on video frame information corresponding to the current block.

S1030: Generate a chrominance component prediction value of the current block based on the cross-component prediction model and a reconstructed luminance component pixel of the current block.

S1040: Perform encoding processing based on the chrominance component prediction value of the current block, to obtain an encoded video bitstream.

For specific implementation details of S1020 and S1030, refer to the descriptions of S710 and S720 in the foregoing embodiment. To be specific, the video encoding device may perform adaptive adjustment to obtain the size of the template area based on the video frame information corresponding to the current block, to avoid increasing costs for hardware implementation as a result of an excessively large template area, and avoid affecting a prediction result as a result of an excessively small template area. In this way, adaptive size adjustment of the template area is achieved. In some embodiments, the video encoding device may alternatively add a flag bit configured for indicating the size of the template area to the video bitstream. The flag bit may include one or more of the following flag bits: a flag bit included in a sequence header, a flag bit included in an image header, a flag bit included in a slice header, a flag bit included in a CTU header, or a flag bit included in a coding block.

In some embodiments, the flag bit included in the sequence header may be configured for indicating that coding blocks in a complete sequence all use a template area of a specified size. The flag bit included in the image header may be configured for indicating that coding blocks in a complete image all use a template area of a specified size. The flag bit included in the slice header may be configured for indicating that coding blocks in a complete slice all use a template area of a specified size. The flag bit included in the CTU header may be configured for indicating that coding blocks in a complete CTU all use a template area of a specified size. The flag bit included in the coding block may be configured for indicating that a current coding block uses a template area of a specified size.

Based on the foregoing, the technical solution in this embodiment of this disclosure involves adaptively selecting the size of the template area used for the cross-component prediction technology based on the video frame information, thereby further improving encoding performance and/or reducing hardware costs. The technical solution in this embodiment of this disclosure may be applied to products such as video codecs. In some embodiments, template areas of different sizes may be used for different blocks in a same CTU or different CTUs.

In some embodiments, the size of the template area may be determined based on a size of a line buffer and a position of the template area. In some examples, it is assumed that a vertical coordinate of a first row of pixels of a current block in a complete image is y, a default size of a CTU is max_cu_height (which, for example, may be a luminance block CTU size in a YUV420 format, and chrominance block CTU size is half of the luminance block CTU size), a size of a line buffer of a chrominance component is K, a default template size (a height or a width) of the cross-component prediction model is set to N, and a finally determined template area size (a height or a width) is M. K, N, and M are non-negative integers.

If the current block is in a first row of CTUs of a video frame, that is, y<(max_cu_height>>1), it is determined whether a distance between y and an upper boundary of a complete video frame satisfies a default template height, to adaptively determine the size of the template area of the prediction model. In some examples, if a distance between the first row of pixels of the current block (that is, a current block for which a chrominance is to be predicted) and the upper boundary of the video frame is greater than or equal to the default template height, a final template area height is set to the default template height. If the distance between the first row of pixels of the current block and the upper boundary of the video frame is less than the default template height, the final template area height is set to the distance between the first row of pixels of the current block and the upper boundary of the video frame. A formula is expressed as follows: if y≥N, M=N; or if y<N, M=y.

If the current block is not in the first row of CTUs of the video frame, that is, y≥(max_cu_height>>1), it is determined whether a position of the template area of the default height exceeds a limit of the line buffer, to adaptively determine the template area height of the prediction model. In some examples, if the default template area of the current block does not exceed a limit of a line buffer of a CTU in which the current block is located, the final template area height is set to the default template height. Conversely, the final template area height is set to a distance between the first row of pixels of the current block and an upper boundary of the CTU in which the current block is located plus a size of the line buffer of the chrominance component. A formula is expressed as follows: if y % (max_cu_height>>1)≥(N−K), M=N; or if y % (max_cu_height>>1)<(N−K), M=(y%(max_cu_height>>1))+K.

In some embodiments, the final template area size may be determined based on a content correlation between the current block and the adjacent area of the current block. This is because theoretically, a higher pixel correlation between the template area and the current block indicates a more suitable cross-component prediction model and prediction parameter that are constructed based on the template area for prediction of the current block. Therefore, the size of the template area may be adaptively selected based on a correlation between the adjacent area of the current block and the reconstructed luminance component pixel of the current block.

In some examples, the size of the template area may be adaptively selected by using a gradient change. For example, an average horizontal gradient

$${G}_{x}^{i}$$

corresponding to all rows of pixels in a horizontal direction and an average vertical gradient

$${G}_{y}^{i}$$

of all columns of pixels in a vertical direction may be separately calculated when the size of the template area changes from 1 to N (x representing the horizontal direction, y representing the vertical direction, and i representing corresponding template size). If the average gradient value does not change significantly as the size of the template area increases from 1 to N, it indicates that a pixel correlation in the template area having the size of N is relatively high, and the final template size may be set as M=N. Conversely, an area size with a smaller change in the average gradient value is used as the final template area size.

The example shown in FIG. 8 is again used as an example. When the width and the height of the template area are 1, the average horizontal gradient is

$${G}_{x}^{1} = ( P 13 - P 1 ) + ( P 14 - P 3 ) ,$$

and the average vertical gradient is

$${G}_{y}^{1} = ( P 7 - P 1 ) + ( P 8 - P 2 ) .$$

When the width and height of the template area are 2, the average horizontal gradient is

$${G}_{x}^{2} = ( ( P 13 - P 1 ) + ( P 14 - P 3 ) + ( P 15 - P 11 ) + ( P 16 - P 12 ) ) / 2 ,$$

$${G}_{y}^{2} = ( ( P 7 - P 1 ) + ( P 8 - P 2 ) + ( P 9 - P 5 ) + ( P 10 - P 6 ) ) / 2.$$

By analogy, the average gradient values corresponding to different template sizes can be separately calculated. If an absolute value of a difference between the average horizontal gradient value of the template size of 2 and the average horizontal gradient value of the template size of 1 is less than a threshold, that is,

$$\vert {G}_{x}^{1} - {G}_{x}^{2} \vert < a ,$$

it is considered that a pixel correlation between the template area having the width of 2 and the template area having the width of 1 in the horizontal direction is high. In this case, a final template width in the horizontal direction may be set to 2. By analogy, gradient values of different template sizes in different directions may be calculated, and a final template size may be obtained based on changes.

In some embodiments, the size of the template area may be adaptively selected by using a difference between the luminance component pixel of the template area and the reconstructed luminance component pixel of the current block. In some examples, the correlation between the luminance component pixel of the template area and the luminance pixel of the current block may be measured based on criteria such as SAD, SSD, and MSE. A higher correlation indicates a more suitable cross-component prediction model and prediction parameter that are constructed based on the template area for prediction of the current block. Generally, the template area has an inverted L shape with a width/height of N (as shown in FIG. 4), and the to-be-predicted block is a rectangle, making it impossible to directly perform point-to-point calculations such as SAD, SSD, or MSE between the two. Therefore, luminance pixels of the template area and the to-be-predicted area may be respectively mapped to spaces of the same width and height, and then point-to-point calculations such as SAD, SSD, or MSE may be performed.

In some embodiments, the size of the template area may be determined based on a block size. This is because blocks of different sizes include different amounts of information and thus require different template area sizes. An excessively large template area may introduce noise into the cross-component prediction model for the current block, while an excessively small template area may result insufficient construction of the cross-component prediction model. Therefore, different template area sizes may be set based on blocks of different sizes, thereby achieving a globally optimal adaptive template area size. An example is shown in the following Table 1:

TABLE 1

| Block size | Template area size |
|---|---|
| max(block_width, block_height) ≤ 8 | 3 |
| 8 < max(block_width, block_height) ≤ 16 | 4 |
| 16 < max(block_width, block_height) ≤ 32 | 4 |
| 32 < max(block_width, block_height) ≤ 64 | 5 |
| 64 < max(block_width, block_height) ≤ 128 | 6 |

In Table 1, block_width represents a width of a current block, block_height represents a height of the current block, and max (block_width, block_height) represents a maximum value of the width and the height of the current block.

In some embodiments, the size of the template area may be determined based on a resolution of an image. This is because images of different solutions include different amounts of information and thus require different template area sizes. An excessively large template area may introduce noise into the cross-component prediction model, while an excessively small template area may result in insufficient construction of the cross-component prediction model. Therefore, different template area sizes may be set based on resolutions of images, thereby achieving a globally optimal adaptive template area size. An example is shown in the following Table 2:

TABLE 2

| Image resolution | Template area size |
|---|---|
| 3840 × 2160 | 6 |
| 1920 × 1080 | 5 |
| 1280 × 720 | 4 |
| 416 × 240 | 3 |

In some embodiments, a video encoder side may select an optimal template area size for a current block, a current CTU, a current slice, or a current frame through rate-distortion optimization, and can indicate the used template area size by transmitting a flag bit. A video decoder side may obtain the template area size used for the current block by parsing a block-level, CTU-level, slice-level, or frame-level flag bit. An example is shown in the following Table 3:

TABLE 3

| Template area size flag bit | Template area size |
|---|---|
| 0 | 6 |
| 11 | 5 |
| 100 | 4 |
| 101 | 3 |

The methods provided in the foregoing embodiments of this disclosure may be used separately or in combination, and may be applied to template area-based video encoding technologies such as intra, inter, and filtering technologies, as well as to products such as video codecs.

An apparatus embodiment of this disclosure is described below, which may be configured for performing the method in the foregoing embodiment of this disclosure. For details not disclosed in the apparatus embodiment of this disclosure, refer to the method embodiments of this disclosure.

FIG. 11 is a block diagram of a cross-component prediction apparatus according to some embodiments of this disclosure. The cross-component prediction apparatus may be applied to a video encoding device or a video decoding device. The video encoding device or the video decoding device may be a terminal device, a server, or the like.

Referring to FIG. 11, a cross-component prediction apparatus 1100 according to some embodiments of this disclosure includes a processing unit 1102 and a generation unit 1104.

The processing unit 1102 is configured to construct, based on a pixel value included in a template area adjacent to a current block, a cross-component prediction model corresponding to the current block, a size of the template area being obtained through adaptive adjustment based on video frame information corresponding to the current block. The generation unit 1104 is configured to generate a chrominance component prediction value of the current block based on the cross-component prediction model and a reconstructed luminance component pixel of the current block.

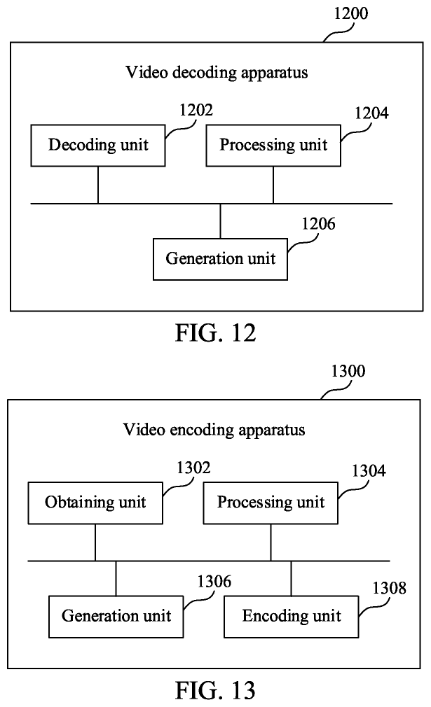

FIG. 12 is a block diagram of a video decoding apparatus according to some embodiments of this disclosure. The video decoding apparatus may be applied to a device having a computing processing function, for example, may be applied to a terminal device or a server.

Referring to FIG. 12, a video decoding apparatus 1200 according to some embodiments of this disclosure includes a decoding unit 1202, a processing unit 1204, and a generation unit 1206.

The decoding unit 1202 is configured to perform decoding processing on a video bitstream, to obtain a pixel value included in a template area adjacent to a current block. The processing unit 1204 is configured to construct, based on the pixel value included in the template area, a cross-component prediction model corresponding to the current block, a size of the template area being determined based on video frame information corresponding to the current block. The generation unit 1206 is configured to generate a chrominance component prediction value of the current block based on the cross-component prediction model and a reconstructed luminance component pixel of the current block, to perform decoding processing based on the chrominance component prediction value of the current block.

FIG. 13 is a block diagram of a video encoding apparatus according to some embodiments of this disclosure. The video encoding apparatus may be applied to a device having a computing processing function, for example, may be applied to a terminal device or a server.

Referring to FIG. 13, a video encoding apparatus 1300 according to some embodiments of this disclosure includes an obtaining unit 1302, a processing unit 1304, a generation unit 1306, and an encoding unit 1308.

The obtaining unit 1302 is configured to obtain a pixel value included in a template area adjacent to a current block. The processing unit 1304 is configured to construct, based on the pixel value included in the template area, a cross-component prediction model corresponding to the current block, a size of the template area being obtained through adaptive adjustment based on video frame information corresponding to the current block. The generation unit 1306 is configured to generate a chrominance component prediction value of the current block based on the cross-component prediction model and a reconstructed luminance component pixel of the current block. The encoding unit 1308 is configured to perform encoding processing based on the chrominance component prediction value of the current block, to obtain an encoded video bitstream.

In some embodiments of this disclosure, based on the foregoing solution, the video bitstream further includes a flag bit configured for indicating a size of the template area. The flag bit includes one or more of the following flag bits: a flag bit included in a sequence header, a flag bit included in an image header, a flag bit included in a slice header, a flag bit included in a CTU header, or a flag bit included in a coding block.

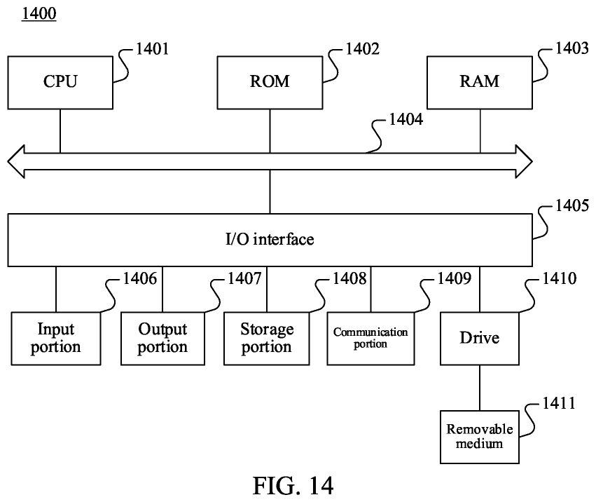

FIG. 14 is a schematic structural diagram of a computer system of an electronic device configured to implement an embodiment of this disclosure. The electronic device may be the cross-component prediction apparatus, the video encoding device, or the video decoding device in the foregoing embodiments.

The computer system 1400 of the electronic device shown in FIG. 14 is an example, and does not constitute any limitation on a function and scope of use of the embodiments of this disclosure.

As shown in FIG. 14, the computer system 1400 may include a central processing unit (CPU) 1401, which may perform various suitable actions and processes based on a program stored in a read-only memory (ROM) 1402 or a program loaded from a storage portion 1408 into a random access memory (RAM) 1403, for example, perform the method in the foregoing embodiments. The RAM 1403 further has stored therein various programs and data required for system operation. The CPU 1401, the ROM 1402, and the RAM 1403 are connected to each other through a bus 1404. An input/output (I/O) interface 1405 is further connected to the bus 1404.

The following components may be connected to the I/O interface 1405: an input portion 1406, including a keyboard, a mouse, and the like; an output portion 1407, including a cathode ray tube (CRT), a liquid crystal display (LCD), a speaker, and the like; a storage portion 1408, including a hard disk; and a communication portion 1409, including a network interface card such as a local area network (LAN) card and a modem. The communication portion 1409 performs communication processing by using a network such as the Internet. A drive 1410 is further connected to the I/O interface 1405 as required. A removable medium 1411, such as a magnetic disk, an optical disk, a magneto-optical disk, or a semiconductor memory, is installed on the drive 1410 as required, so that a computer program read out therefrom is installed into the storage portion 1408 as required.

For example, according to the embodiments of this disclosure, the foregoing processes described with reference to the flowcharts may be implemented as computer software programs. For example, an embodiment of this disclosure includes a computer program product, including a computer program carried on a computer readable medium. The computer program is configured for performing the methods shown in the flowcharts. In such an embodiment, the computer program may be downloaded and installed from a network through the communication portion 1409, and/or installed from the removable medium 1411. When the computer program is executed by the CPU 1401, various functions defined in the system of this disclosure are performed.

The computer-readable medium shown in this embodiment of this disclosure may be a computer-readable signal medium, a computer-readable storage medium, or any combination of the two. The computer-readable storage medium may be, for example, an electric, magnetic, optical, electromagnetic, infrared, or semiconductor system, apparatus, device, or any combination thereof, but is not limited thereto. More specific examples of the computer-readable storage medium may include, but are not limited to, an electrical connection having one or more wires, a portable computer magnetic disk, a hard disk, a RAM, a ROM, an erasable programmable read-only memory (EPROM), a flash memory, an optical fiber, a portable compact disk read-only memory (CD-ROM), an optical storage device, a magnetic storage device, or any proper combination thereof. In this disclosure, the computer-readable storage medium may be any tangible medium that includes a computer program or has a computer program stored therein. The computer program may be used by or used in combination with an instruction execution system, apparatus, or device. In this disclosure, the computer-readable signal medium may include a data signal transmitted in a baseband or as a part of a carrier, and carries a computer-readable computer program. The propagated data signal may be in various forms, including but not limited to an electromagnetic signal, an optical signal, or any proper combination thereof. The computer-readable signal medium may alternatively be any computer-readable medium other than the computer-readable storage medium. The computer-readable medium can send, propagate, or transmit a program used by or in combination with an instruction execution system, apparatus, or device. The computer program included in the computer-readable medium may be transmitted by using any suitable medium, including but not limited to a wireless medium, a wired medium, or any proper combination thereof.

The flowcharts and the block diagrams in the drawings illustrate possible system architectures, functions, and operations that may be implemented by a system, a method, and a computer program product according to various embodiments of this disclosure. Each box in the flowcharts or the block diagrams may represent a module, a program segment, or a part of code. The module, the program segment, or the part of the code includes one or more executable instructions configured for implementing a specified logical function. In some alternative implementations, the functions marked in the blocks may occur in an order different from that marked in the drawings. For example, two boxes shown in succession may actually be performed basically in parallel, and sometimes the two boxes may be performed in a reverse order. This depends on the functions involved. Each box in the block diagrams or the flowcharts and combinations of boxes in the block diagrams or the flowcharts may be implemented by a dedicated hardware-based system that performs specified functions or operations, or may be implemented by a combination of dedicated hardware and a computer program.

The units involved in the description of this embodiment of this disclosure may be implemented by software or hardware, or the described units may be arranged in a processor. Names of the units do not constitute a limitation on the units in a specific case.

As another aspect, this disclosure further provides a computer-readable medium. The computer-readable medium may be included in the electronic device described in the foregoing embodiment. Alternatively, the electronic device may exist alone and is not assembled in the electronic device. The computer-readable medium carries one or more computer programs, and when the one or more computer programs are executed by the electronic device, the electronic device is caused to implement the methods described in the foregoing embodiments.

Although a plurality of modules or units of a device configured to perform actions are mentioned in the foregoing detailed description, such division is not mandatory. Actually, according to the implementations of this disclosure, features and functions of two or more modules or units described above may be specifically implemented in one module or unit. On the contrary, features and functions of one module or unit described above may be further specifically implemented by a plurality of modules or units.

Through the foregoing descriptions of the implementations, the implementations described herein may be implemented by software, or may be implemented by a combination of software with necessary hardware. Therefore, the technical solutions according to the implementations of this disclosure may be implemented in a form of a software product. The software product may be stored in a non-volatile storage medium (which may be a CD-ROM, a USB flash drive, a removable hard disk, or the like) or on a network, including a plurality of instructions configured for enabling an electronic device to perform the methods according to the implementations of this disclosure.

For example, the electronic device may be a cross-component prediction apparatus. In this case, the cross-component prediction apparatus may perform the cross-component prediction method shown in FIG. 7. For another example, the electronic device may be a video decoding device. In this case, the video decoding device may perform the video decoding method shown in FIG. 9. For another example, the electronic device may be a video encoding device. In this case, the video encoding device may perform the video encoding method shown in FIG. 10.

An embodiment of this disclosure further includes a non-volatile computer-readable storage medium, having stored therein a bitstream formed by a computer program, the non-volatile computer-readable storage medium being configured to store one or more groups of instructions configured to be executed by a computing device having a control circuit and a memory, and when the one or more groups of instructions are executed, the video decoding method shown in FIG. 9 being implemented.

An embodiment of this disclosure further includes a method for storing or transmitting a video bitstream, the video bitstream being generated according to the video encoding method shown in FIG. 10, or the video bitstream being decoded according to the video decoding method shown in FIG. 9.

An embodiment of this disclosure further includes a computer storage medium, having instructions stored therein, the instructions being executable by at least one processor to perform the video encoding method shown in FIG. 10, to generate and store a bitstream.

Other implementations of this disclosure may be performed after considering the specification and practicing the implementations disclosed herein. This disclosure is intended to cover any variations, usages, or adaptive changes of this disclosure. These variations, usages, or adaptive changes follow the general principles of this disclosure and include common general knowledge or common technical means in the art not disclosed in this disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing disclosure includes some embodiments of this disclosure which are not intended to limit the scope of this disclosure. Other embodiments shall also fall within the scope of this disclosure.

What is claimed is:

1. A method of cross-component prediction, the method comprising:
constructing, based on one or more pixels in a template area adjacent to a current block in a current frame, a cross-component prediction model for the current block, a size of the template area for constructing the cross-component prediction model for the current block being determined based on one or more attributes of the current block, the template area comprising at least one of a first area on a left side of the current block and a second area above the current block, the size of the template area comprising at least one of a width of the first area and a height of the second area, and the one or more attributes of the current block comprising at least one of a position of the current block in the current frame, a correlation between the current block and an adjacent area of the current block, a size of the current block, and a resolution of the current frame; and
generating at least a predicted chrominance component value of a pixel in the current block based on the cross-component prediction model and a reconstructed luminance component value of the pixel.

2. The method according to claim 1, wherein the method further comprises at least one of:
determining the height of the second area based on a distance between a first row of pixels in the current block and an upper boundary of the current frame when the current block is in a first row of coding tree units (CTUs) in the current frame; and
determining the height of the second area based on a position relationship between a default template area and a line buffer region for a target row of CTUs including the current block when the current block is not in the first row of CTUs in the current frame.

3. The method according to claim 2, wherein:
the current block is in the first row of CTUs in the current frame;
when the distance between the first row of pixels in the current block and the upper boundary of the current frame is greater than or equal to a default height of the second area, the default height is used as the height of the second area; and
when the distance between the first row of pixels in the current block and the upper boundary of the current frame is less than the default height of the second area, the distance is used as the height of the second area.

4. The method according to claim 2, wherein:
the current block is not in the first row of CTUs in the current frame;
a default height of the second area as the height of the second area is used when the default template area does not exceed the line buffer region; and
a sum of a distance between the first row of pixels in the current block and an upper boundary of the target row of CTUs and a size of the line buffer region as the height of the second area is used when the default template area exceeds the line buffer region.

5. The method according to claim 2, further comprising:
setting the width of the first area of a same value as the height of the second area.

6. The method according to claim 2, further comprising:
determining the width of the first area based on a distance between a first column of pixels in the current block and a left boundary of the current frame when the current block is in a first column of CTUs in the current frame.

7. The method according to claim 1, wherein the size of the template area is determined based on the correlation between the current block and the adjacent area of the current block, the method further comprises:
determining the size of the template area based on a correlation between first reconstructed luminance component values of one or more first pixels in the current block and second reconstructed luminance component values of one or more second pixels in the adjacent area.

8. The method according to claim 7, wherein the determining the size of the template area comprises:
performing one or more rounds that extend the width of the first area leftward with a fixed right boundary of the first area until the width is set or the width is extended to a default width, and
for a round in the one or more rounds that extends the width of the first area from i−1 to i, i being a natural number greater than 1, the method comprises:
comparing a first average horizontal gradient associated with the width being i−1 and a second average horizontal gradient associated with the width being i, the first average horizontal gradient being calculated based on luminance component of pixels in the first area when the width is i−1, and the second average horizontal gradient being calculated based on luminance component of pixels in the first area when the width is i;
setting the width of the first area to i−1 when an absolute difference between the second average horizontal gradient and the first average horizontal gradient is greater than or equal to a threshold; and
performing a next round that further extends the width of the first area leftward when the absolute difference is less than the threshold.

9. The method according to claim 7, wherein the determining the size of the template area comprises:
performing one or more rounds that extend the height of the second area upward with a fixed lower boundary until the height is set or the height is extended to a default height, and
for a round in the one or more rounds that extends the height of the second area from j−1 to j, j being a natural number greater than 1, the method comprises:
comparing a first average vertical gradient associated with the height being j−1 and a second average vertical gradient associated with the height being j, the first average vertical gradient being calculated based on luminance component of pixels in the second area when the height is j−1, and the second average vertical gradient being calculated based on luminance component of pixels in the second area when the height is j;
setting the height of the second area to j−1 when an absolute difference between the second average vertical gradient and the first average vertical gradient is greater than or equal to a threshold; and
performing a next round that further extends the height of the second area upward when the absolute difference is less than the threshold.

10. The method according to claim 7, wherein the determining the size of the template area comprises:
performing one or more rounds that extend the width of the first area leftward with a fixed right boundary and extend the height of the second area upward with a fixed lower boundary until the width and the height are set or the height and the width are extended to a default value, and
for a round in the one or more rounds that extends the width of the first area and the height of the second area from l−1 to l,l being a natural number greater than 1, the method comprises:
calculating a pixel value error based on pixels in the template area when the width of the first area and the height of the second area are l, the pixel value error being calculated based on luminance component difference between the template area and the current block;
setting the width of the first area and the height of the second area to l-1 when the pixel value error is greater than or equal to a threshold; and
performing a next round that further extends the width of the first area and the height of the second area when the pixel value error is less than the threshold.

11. The method according to claim 10, wherein the calculating the pixel value error comprises:
mapping luminance component of pixels in the template area to a first spatial area to obtain a first mapping result;
mapping reconstructed luminance component of pixels in the current block to a second spatial area of a same size as the first spatial area to obtain a second mapping result; and
calculating a pixel value error between the first mapping result and the second mapping result.

12. The method according to claim 1, wherein the size of the template area is determined based on the size of the current block, the method further comprises:
determining the size of the template area with a positive correlation to the size of the current block, and the size of the current block being a larger one of a width and a height of the current block.

13. The method according to claim 1, wherein the size of the template area is determined based on the resolution of the current frame, the method further comprises:
determining the size of the template area with a positive correlation to the resolution of the current frame.

14. The method according to claim 1, wherein the cross-component prediction model comprises one of:
a cross-component nonlinear prediction model for intra prediction, a cross-component linear prediction model for intra prediction, a cross-component nonlinear prediction model for inter prediction, and a cross-component linear prediction model for inter prediction.

15. A method of video decoding, the method comprising:
receiving a video bitstream comprising coded information of a current frame including a current block;
determining a size of a template area of the current block based on one or more attributes of the current block, the template area comprising at least one of a first area on a left side of the current block and a second area above the current block, the size of the template area comprising at least one of a width of the first area and a height of the second area, and the one or more attributes of the current block comprising at least one of a position of the current block in the current frame, a correlation between the current block and an adjacent area of the current block, a size of the current block, and a resolution of the current frame;
constructing, based on one or more pixels in the template area, a cross-component prediction model for the current block;
generating at least a predicted chrominance component value of a pixel in the current block based on the cross-component prediction model and a reconstructed luminance component value of the pixel; and
reconstructing the current block based on the predicted chrominance component value of the pixel.

16. The method according to claim 15, further comprising:
determining values of one or more flags from the video bitstream; and
determining the size of the template area according to the values of the one or more flags.

17. The method according to claim 16, wherein the one or more flags comprise at least one of a flag in a sequence header, a flag in a picture header, a flag in a slice header, a flag in a coding tree unit (CTU) header, and a flag at a block level associated with the current block.

18. A method of video encoding, the method comprising:
determining a size of a template area of a current block in a current frame based on one or more attributes of the current block, the template area comprising at least one of a first area on a left side of the current block and a second area above the current block, the size of the template area comprising at least one of a width of the first area and a height of the second area, and the one or more attributes of the current block comprising at least one of a position of the current block in the current frame, a correlation between the current block and an adjacent area of the current block, a size of the current block, and a resolution of the current frame;
constructing, based on one or more pixels in the template area, a cross-component prediction model for the current block;
generating at least a predicted chrominance component value of a pixel in the current block based on the cross-component prediction model and a reconstructed luminance component value of the pixel; and
encoding the current block into coded information in a video bitstream based on the predicted chrominance component value of the pixel.

19. The method according to claim 18, further comprising:
encoding one or more flags into the coded information in the video bitstream, the one or more flags indicating the size of the template area.

20. The method according to claim 19, wherein the one or more flags comprise at least one of a flag in a sequence header, a flag in a picture header, a flag in a slice header, a flag in a coding tree unit (CTU) header, and a flag at a block level associated with the current block.
